(19) United States
(12) Patent Application Publication
(10) Pub. No.: US 2015/0185957 A1
(43) Pub. Date: Jul. 2, 2015

(54) TOUCH NAKED EYES STEREOSCOPIC DISPLAY

(71) Applicant: HannStar Display Corporation, New Taipei City (TW)

(72) Inventors: Chia-Shin WENG, Chiayi City (TW); Fei-Shun CHEN, Yunlin County (TW)

(73) Assignee: HannStar Display Corporation, New Taipei City (TW)

(21) Appl. No.: 14/142,942

(22) Filed: Dec. 30, 2013

(51) Int. Cl. G06F 3/042; H04N 13/04; G02B 27/22; G06F 3/041

(52) U.S. Cl. CPC G06F 3/0421; G06F 3/0416; H04N 13/0409; G02B 27/22

(57) ABSTRACT

A touch naked eyes stereoscopic display provided includes a touch display module and a backlight module. The touch display module includes an array substrate, a touch panel and a display medium. The display medium is directly configured between the array substrate and the touch panel. The backlight module includes a stereoscopic optical splitting sheet, a first light source and a second light source. The stereoscopic optical splitting sheet is configured on one side of the array substrate back opposite to the touch panel. The first light source and the second light source are configured on two opposite side surfaces of the stereoscopic optical splitting sheet respectively, wherein only the first light source provides red lights to the stereoscopic optical splitting sheet and only the second light source provides blue lights to the stereoscopic optical splitting sheet.

### BACKGROUND

1. Field of Disclosure

The invention relates to a naked eyes stereoscopic display. More particularly, the invention relates to a touch naked eyes stereoscopic display.

2. Description of Related Art

Generally, a flat-plane naked eyes stereoscopic display adopts lens or a protective screen to produce stereoscopic images for viewers without glasses filters. Substantially, the flat-plane naked eyes stereoscopic display degrades a certain definition of the stereoscopic images with a pixel alternate arrangement of the stereoscopic display, and then provides two different eye-saw images respectively, so as to generate a stereoscopic visual effect.

In addition, some vendors apply the touch technology into the flat-plane naked eyes stereoscopic display. That is, a touch panel is configured above a plane surface of the display, so that an outmost layer of the whole display can be touched and used by users.

As shown in FIG. 1, it is an element configuration relationship view of a known capacitance touch naked eyes stereoscopic display which mainly uses a capacitance touch and a liquid crystal optical grating to achieve an effect of a naked eyes stereoscopic display and the touch panel is integrated on the naked eyes stereoscopic display to achieve an effect of a capacitance touch naked eyes stereoscopic display.

This capacitance touch naked eyes stereoscopic display includes a display device 1, an optical grating 2 and a touch panel 3. The display device 1 includes a display panel 11, an integrated circuit 12, a backlight module 13 and a printed circuit board 14. The optical grating 2 includes a liquid crystal optical grating 21. The touch panel 3 includes a capacitance touch substrate 31, a cover lens 32 and a flexible printed circuit board 33.

However, as shown in the FIG. 1, the existing touch naked eyes stereoscopic display at least still needs to cooperate with five or six pieces of glass sheets at least as a whole, so that the total weight and thickness still need to be improved.

Therefore, how to provide a solution to effectively solve the aforementioned problem that light weight and thinning of the touch naked eyes stereoscopic display are not realized easily for improving the portability of electronic products, shall be a serious issue to be concerned.

### SUMMARY

One aspect of the present invention is to provide a touch naked eyes stereoscopic display which solves the problem that the light weight and thinning of the traditional touch naked eyes stereoscopic display cannot be realized easily, thereby improving the portability space utility rate of electronic products.

Another aspect of the present invention is to provide a touch naked eyes stereoscopic display which can choose not to use a color filter, so as to increase the light penetration rate and reduce the manufacturing cost.

The invention provides a touch naked eyes stereoscopic display, including a touch display module and a backlight module. The touch display module includes an array substrate, a touch panel and a display medium. The touch panel is configured on one side of the array substrate and the display medium is directly configured between the array substrate and the touch panel. The backlight module includes a stereoscopic optical splitting sheet, a first light source and a second light source. The stereoscopic optical splitting sheet is configured on one side of the array substrate back opposite to the touch panel, including a first side surface and a second side surface opposite to each other. The first light source and the second light source are configured on the first side surface and the second side surface of the stereoscopic optical splitting sheet respectively. In the first light source and the second light source, only the first light source provides red lights to the stereoscopic optical splitting sheet and only the second light source provides blue lights to the stereoscopic optical splitting sheet.

In an embodiment of the invention, the touch panel includes a substrate and a touch sensing electrode pattern. The touch sensing electrode pattern is embedded in the substrate, and located on an internal side surface of the substrate.

In an embodiment of the invention, the touch panel includes a substrate and a touch sensing electrode pattern. The touch sensing electrode pattern is covered on an external side surface of the substrate.

In a variation of the above-mentioned embodiment, the touch sensing electrode pattern includes multiple first axial sensing electrodes parallel to each other and multiple second axial sensing electrodes parallel to each other. These first axial sensing electrodes and second axial sensing electrodes are configured on the same surface of the substrate.

In another variation of the above-mentioned embodiment, the touch sensing electrode pattern includes multiple first axial sensing electrodes parallel to each other and multiple second axial sensing electrodes parallel to each other. These first axial sensing electrodes and second axial sensing electrodes are configured on different surfaces of the substrate.

In an embodiment of the invention, each of the first side surface and the second side surface of the stereoscopic optical splitting sheet is a light-incident surface. The first side surface receives red lights from the first light source, and the second side surface receives blue lights from the second light source.

In an embodiment of the invention, the backlight module further includes a light guide plate. The light guide plate includes two light-incident surfaces opposite to each other, and a light outputting surface. The stereoscopic optical splitting sheet is attached onto the light outputting surface which is configured between the two light-incident surfaces. The two light-incident surfaces face the first light source and the second light source respectively for receiving red lights from the first light source and blue lights from the second light source.

In an embodiment of the invention, the first light source or the second light source further provides green lights.

In an embodiment of the invention, the backlight module further includes a field sequential color driving circuit. The field sequential color driving circuit drives the first light source and the second light source alternately.

In an embodiment of the invention, the stereoscopic optical splitting sheet is directly configured on one side of the array substrate, and the stereoscopic optical splitting sheet includes a film body and multiple optical micro-structures which are arranged on one surface of the film body facing the array substrate.

In view of the above, since the touch naked eyes stereoscopic display of the invention can realize the features of light weight and thinning so that the display can be at least simplified including only the array substrate sheet and the touch panel sheet (such as a glass sheet), the problem that the light weight and thinning of the traditional touch naked eyes stereoscopic display cannot be realized easily can be solved effectively, thereby improving the portability space utility rate of electronic products.

### BRIEF DESCRIPTION OF THE DRAWINGS

In order to make the foregoing as well as other purposes, features, advantages and embodiments of the invention more apparent, the accompanying drawings are described as follows:

FIG. 1 is an element configuration relationship view of a known capacitance touch naked eyes stereoscopic display;

FIG. 2 is a schematic view of a touch naked eyes stereoscopic display according to an embodiment of the invention;

FIG. 3A is a schematic view of a variation of the touch panel in FIG. 2 in the embodiment;

FIG. 3B is a schematic view of another variation of the touch panel in FIG. 2 in the embodiment;

FIG. 4A is a schematic view of further another variation of the touch panel in FIG. 2 in the embodiment;

FIG. 4B is a schematic view of still further another variation of the touch panel in FIG. 2 in the embodiment;

FIG. 5 is a schematic view of a variation of the backlight module in FIG. 2 in the embodiment;

FIG. 6A is a schematic view of a variation of the first light source in FIG. 2 in the embodiment;

FIG. 6B is a schematic view of a variation of the second light source in FIG. 2 in the embodiment; and

FIGS. 7A and 7B are operational schematic views of the touch naked eyes stereoscopic display of the invention.

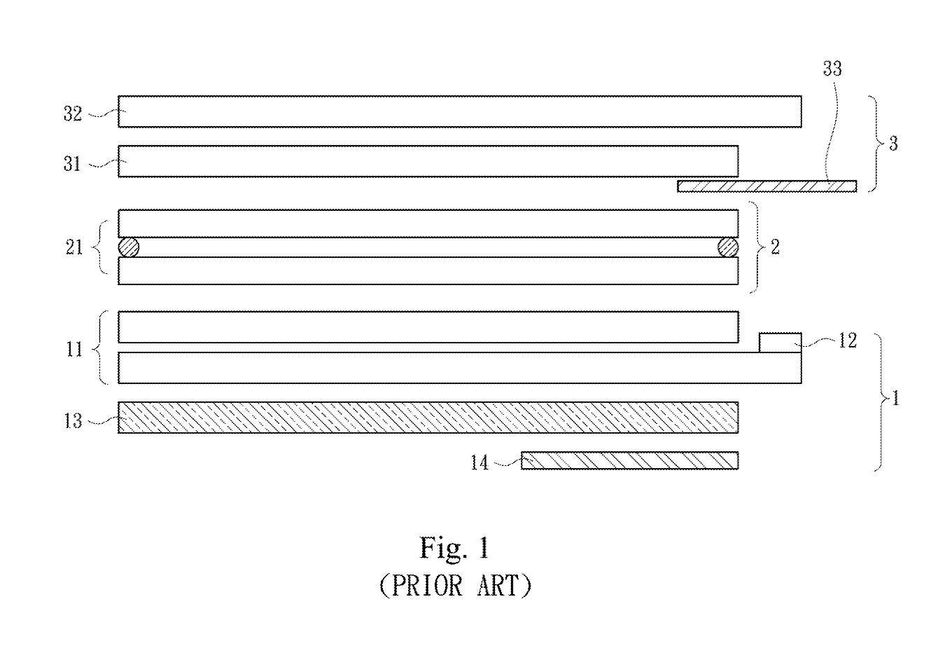

### DETAILED DESCRIPTION

The spirit of the invention will be described in details in the following accompanying drawings and detailed description. After those of skills in the art learn the embodiments of the invention, with technical teachings in the invention, modifications and variations can be made, without departing from the spirit and scope of the invention.

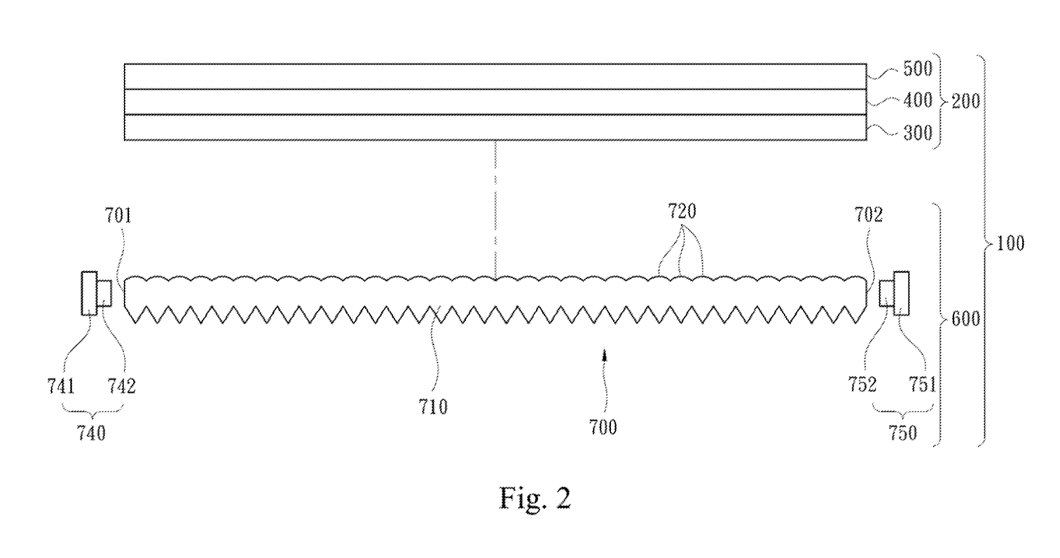

FIG. 2 is a schematic view of a touch naked eyes stereoscopic display 100 according to an embodiment of the invention.

Referring to FIG. 2, the touch naked eyes stereoscopic display 100 includes a touch display module 200 and a backlight module 600. The touch display module 200 includes an array substrate 300, a touch substrate 500 and a display medium 400. The touch substrate 500 is stacked above the array substrate 300. The display medium 400 is directly sandwiched between the array substrate 300 and the touch substrate 500. The array substrate 300, whose material is, for example, glass or other transparent material, is an active element array substrate having multiple pixel units. The display medium 400 is, for example, a liquid crystal layer or other material. The touch substrate 500, whose material, for example, is glass or other transparent material, is an opposite substrate on the touch display module 200 to package the display medium 400 with the array substrate 300, on the other hand, the touch substrate 500 also is an interface available for users to touch and use.

The backlight module 600 includes a stereoscopic optical splitting sheet 700, a first light source 740 and a second light source 750. The stereoscopic optical splitting sheet 700 is configured on one side of the array substrate 300 which is opposite to the touch substrate 500, and more particular, the stereoscopic optical splitting sheet 700 is directly configured on one side surface of the array substrate 300 which is opposite to the touch substrate 500. Particularly, the stereoscopic optical splitting sheet 700 includes a film body 710 and multiple optical micro-structures 720 which are arranged on one main surface of the film body 710 facing the array substrate 300. The stereoscopic optical splitting sheet 700 includes multiple lateral side surfaces, including a first side surface 701 and a second side surface 702 opposite to each other.

In addition, in an option of the embodiment, the stereoscopic optical splitting sheet 700 can be an optical plate having a directional back light unit 3D film commercially available from 3M® Company, for example. The stereoscopic optical splitting sheet 700 can guide the emitted lights to two eyes of a viewer respectively, so that the left eye picture and the right eye picture can be projected into the left eye and the right eye of the viewer in a fast and alternate manner, in order to form a stereoscopic picture. Since the directional back light unit 3D film is a known product, please refer to U.S. patent (U.S. Pat. No. 8,068,187) and U.S. patent (U.S. Pat. No. 8,179,362).

The first light source 740 is configured on the first side surface 701 of the stereoscopic optical splitting sheet 700 and the first light source 740 includes a first circuit substrate 741 and multiple first light emitting units 742 arranged at intervals on the first circuit substrate 741. The second light source 750 is configured on the second side surface 702 of the stereoscopic optical splitting sheet 700 and the second light source 750 includes a second circuit substrate 751 and multiple second light emitting units 752 arranged at intervals on the second circuit substrate 751. These first light emitting units 742 are red light emitting diodes facing the first side surface 701 to emit red lights and these second light emitting units 752 are blue light emitting diodes facing the second side surface 702 to emit blue lights.

It is noted that, in the embodiment, in the first light source 740 and the second light source 750, only the first light source 740 provides red lights to the stereoscopic optical splitting sheet 700 instead of blue lights, and only the second light source 750 provides blue lights to the stereoscopic optical splitting sheet 700 instead of red lights. In other words, blue lights and red lights must be provided on the two opposite side surfaces 701 and 702 of the stereoscopic optical splitting sheet 700 respectively.

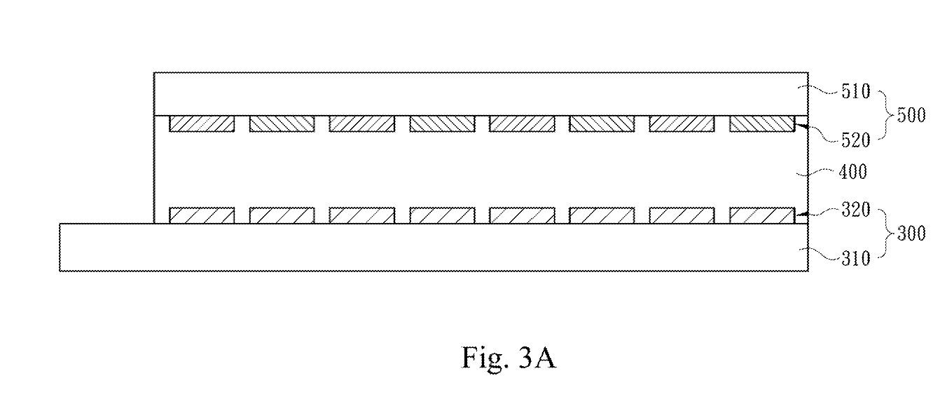

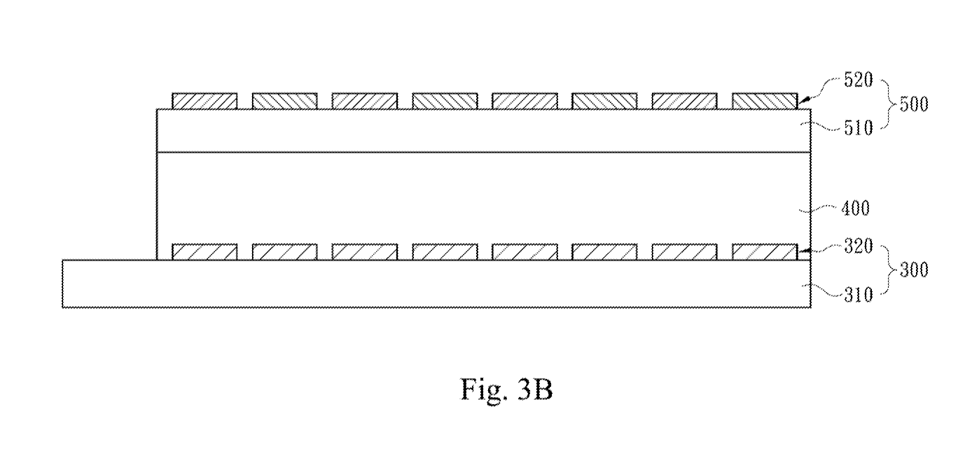

FIG. 3A is a schematic view of a variation of the touch substrate 500 in FIG. 2 in the embodiment. Referring to FIGS. 2 and 3A, the touch substrate 500 of the touch display module 200 includes a substrate 510 and a touch sensing electrode pattern 520. The substrate 510 is preferably a cover lens, for example. The touch sensing electrode pattern 520 is directly manufactured on an internal side surface of the substrate 510 in an in-cell manufacturing manner, so that the touch sensing electrode pattern 520 is embedded in the touch display module 200 to be protected by the substrate 510. Therefore, it is unnecessary to add an additional cover lens for protection outside of the touch substrate 500. The array substrate 300 of the touch display module 200 includes a substrate 310 and a pixel electrode pattern 320. In a variation of the embodiment, the touch substrate 500 is not limited to whether a capacitance type or a resistance type thereof. However, the invention is not limited to the described features above.

FIG. 3B is a schematic view of another variation of the touch substrate 500 in FIG. 2 in the embodiment. Referring to FIGS. 2 and 3B, the touch substrate 500 includes a substrate 511 and a touch sensing electrode pattern 521. The touch sensing electrode pattern 521 is directly manufactured on an external side surface of the substrate 511 in an on-cell manufacturing manner, so that the touch sensing electrode pattern 521 is covered on the external side surface of the substrate 511. Therefore, a cover lens for protection can be optionally added to the touch substrate 500. In a variation of the embodiment, the touch substrate 500 is not limited to whether a capacitance type or a resistance type thereof. However, the invention is not limited to the described features above.

In addition, in the structure of the touch panel, it can be mainly divided into two ways. The first way is a single-layer touch panel and the second way is a two-sided touch panel.

For the single-layer touch panel, the touch sensing electrode pattern is configured on the same side surface of the substrate and its specific structure varies very widely. In the invention, the structure of such a single-layer touch panel does not limit the type variation of the substrate deliberately. For example, the specific features disclosed in U.S. Patent Publication (US 20100163394), U.S. Patent Publication (US 20100214247), U.S. Patent Publication (US 20110187672), U.S. Patent Publication (US 20110279401), U.S. Patent Publication (US 20120026126), U.S. Patent Publication (US 20120062506), U.S. Patent Publication (US 20120062507), U.S. Patent Publication (US 20120062511), U.S. Patent Publication (US 20120081331), U.S. Patent Publication (US 20120113361), U.S. Patent Publication (US 20120319966), and U.S. Patent Publication (US 20130021289) are also included in the invention.

For example, in U.S. Patent Publication (US 20120062506), the single-layer touch panel is formed by multiple first type electrode patterns and second type electrode patterns. Each of the first type electrode patterns shows an acute angle shape (e.g., regular triangle) and every two of the first type electrode patterns are configured oppositely. The second type electrode pattern is configured in an external side area of the first type electrode pattern. The first type electrode pattern can prevent an electrode wiring in the area which an image passes through.

The second type electrode pattern has unique coordinate information so as to improve the touch sensibility. Moreover, in U.S. Patent Publication (US 20120081331), the touch sensing electrode pattern of the single-layer touch panel includes multiple transparent electrodes, including internal transparent electrodes and external transparent electrodes. The internal transparent electrodes have sensing units and extension parts which extend from the sensing units towards an edge of a transparent substrate, so that every two adjacent sensing units face each other. Therefore, the extension parts facing each other can reduce a frequency generating coordinate errors when the extension parts are touched by fingers. Moreover, specific features disclosed by U.S. Patent Publication (US 20110279401), U.S. Patent Publication (US 20120062507), and others are also included in the invention.

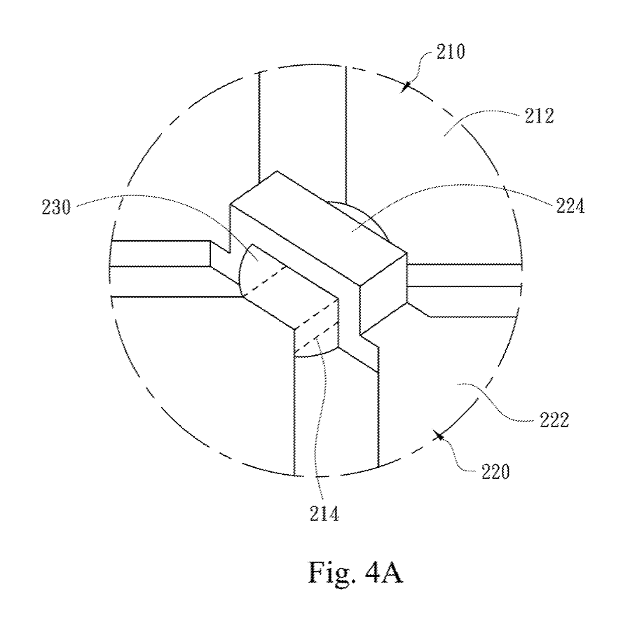

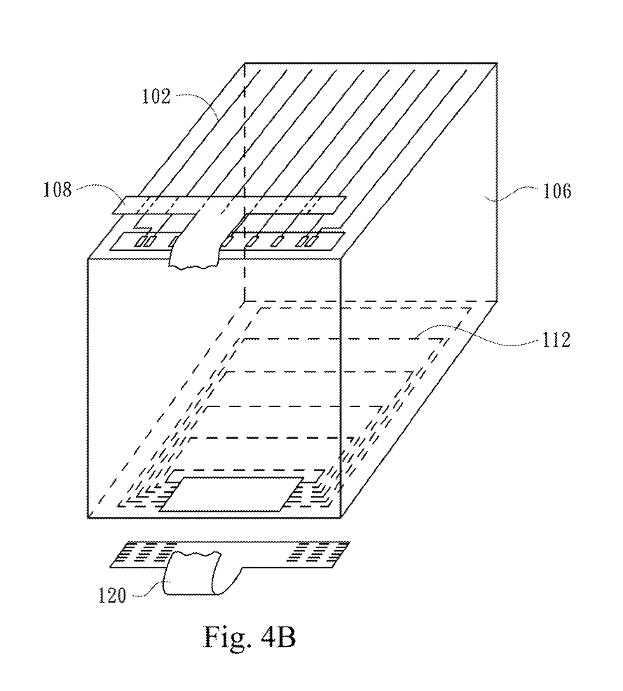

As shown in FIG. 4A, FIG. 4A is a schematic view of further another variation of the touch panel in FIG. 2 in the embodiment. In U.S. Patent Publication (US 20120062507), the touch sensing electrode pattern includes a first axial sensing electrode 210 and a second axial sensing electrode 220. The first axial sensing electrode 210 has at least two first sensing electrodes 212 and a first connection part 214 which is connected to the two first sensing electrodes of the first axial sensing electrode. The second axial sensing electrode 220 has at least two second sensing electrodes 212 and a second connection part 224 which is connected to the two second sensing electrodes 222 of the second axial sensing electrode through a jumper manner and crosses above the first connection part 214. By an insulation part 230, the second connection part 224 and the first connection part 214 are insulated from each other.

In the second way, the touch sensing electrode pattern of a double side Indium Tin Oxide (DITO) is configured on two different side surfaces of the substrate and its specific structure varies very widely. In the invention, the structure of such a two-sided touch panel does not limit the type variation of the substrate deliberately. For example, the specific features disclosed in U.S. Patent Publication (US 20100309162), U.S. Patent (U.S. Pat. No. 7,999,795) and U.S. Patent Publication (US 20080309633) are also included in the invention.

As shown in FIG. 4B, FIG. 4B is a schematic view of still further another variation of the touch panel in FIG. 2 in the embodiment. For example, in U.S. Patent Publication (US 20080309633), the touch sensing electrode pattern includes a plurality of first axial sensing electrodes 102 paralleled with each other, and a plurality of second axial sensing electrodes 112 paralleled with each other. The first axial sensing electrodes 102 are configured on one side surface of the substrate 106, the second axial sensing electrodes 112 are configured on the other side surface of the substrate 106 opposite to the side surface of the substrate 106, and an alignment of the first axial sensing electrodes 102 and an alignment of the second axial sensing electrodes 112 are orthogonal with each other. Also, the first axial sensing electrodes 102 and the second axial sensing electrodes 112 are electrically connected with each other by flexible circuit boards 108, 120.

The variation of the above-mentioned touch substrate 500 is also not limited to those described features. For example, the touch substrate 500 also can be both a glass-on-glass (G/G) structure and a one-glass-solution (OGS) structure.

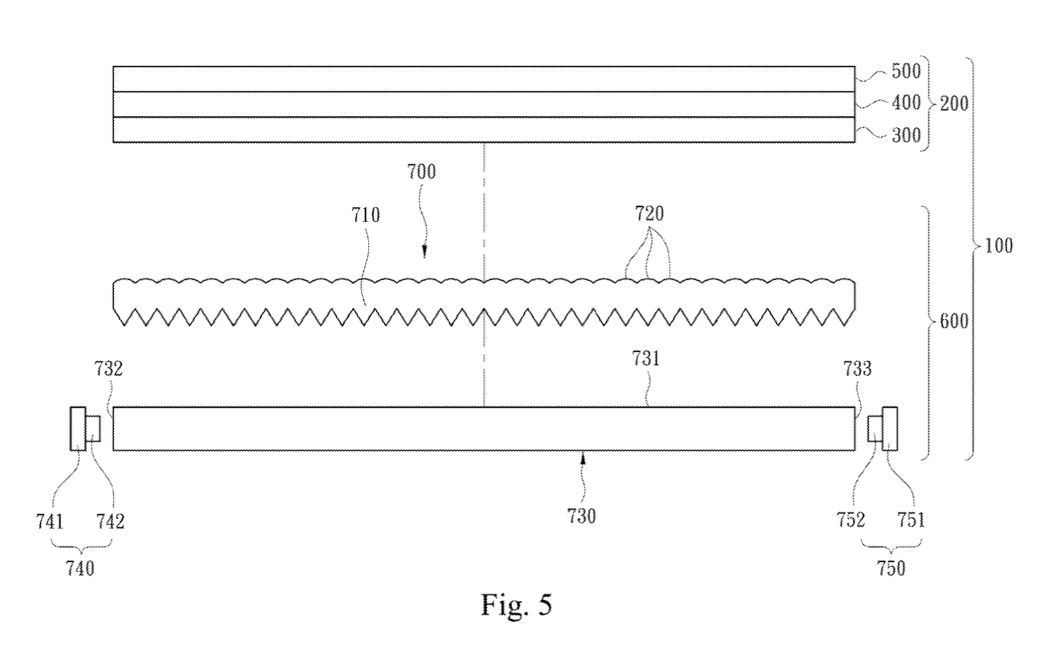

FIG. 5 is a schematic view of a variation of the backlight module 600 in FIG. 2 in the embodiment. Referring to FIGS. 2 and 5, in an embodiment of the invention, the backlight module 600 further includes a light guide plate 730. The light guide plate 730 is provided with a first surface and a second surface opposite to each other, and the light guide plate 730 is provided with four third surfaces which surround the first surface and the second surface, and are adjacently connected to the first surface and the second surface thereof. The third surfaces are referred to surfaces which show the thickness of the light guide plate 730, and any third surface has an area smaller than that of the first surface or the second surface.

Generally, the first surface or the second surface of the light guide plate 730 can be designed as a light outputting surface 731 and any two opposite third surfaces of the light guide plate 730 can be designed as a first light-incident surface 732 and a second light-incident surface 733. The stereoscopic optical splitting sheet 700 is directly attached on the light outputting surface 731 and is sandwiched between the array substrate 300 and the light guide plate 730. The first light source 740 and the second light source 750 face the first light-incident surface 732 and the second light-incident surface 733 respectively, so that the first light emitting units 742 of the first light source 740 emit red lights to the first light-incident surface 732 of the light guide plate 730 and the second light emitting units 752 of the second light source emit blue lights to the second light-incident surface 733 of the light guide plate 730.

In addition, the material of the light guide plate is transparent material, such as polyethylene terephthalate (PET), polycarbonate (PC) or poly(methyl methacrylate) (PMMA). However, the invention is not limited to those options. Moreover, the appearance of the light guide plate (e.g., sheet-shaped or curl-shaped) can be decided depending on the selection of thickness or softness and hardness degree of the light guide plate. However, the invention is not limited to this.

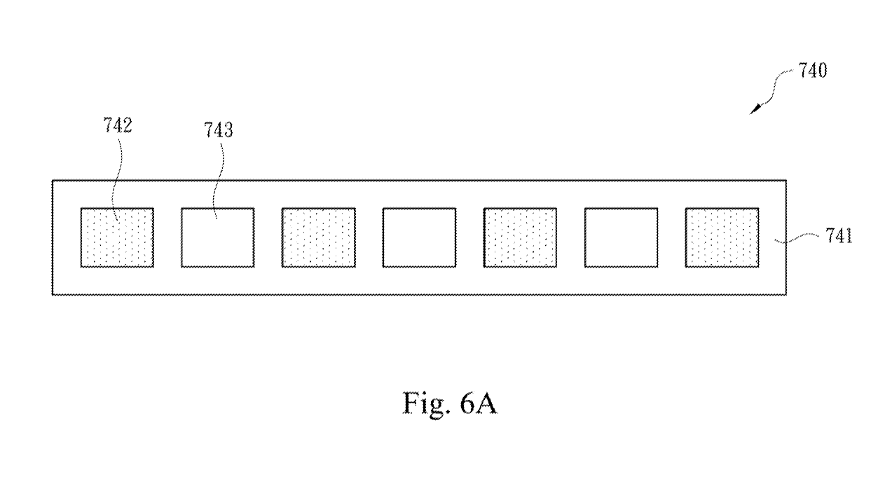

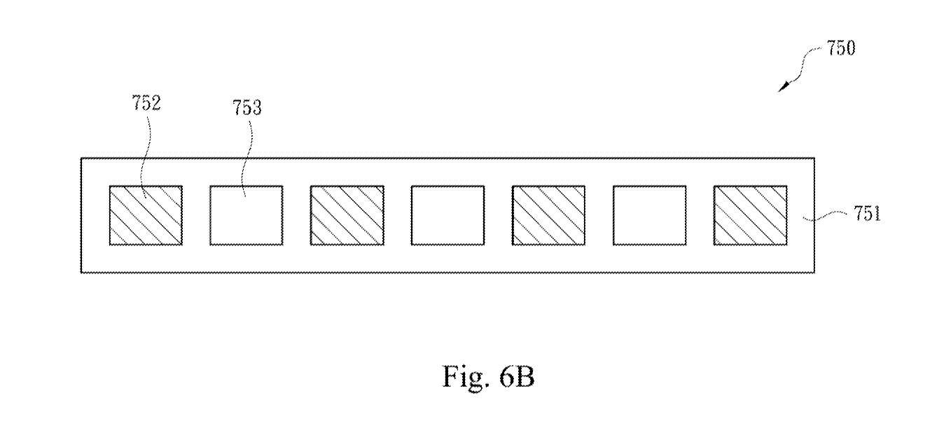

Referring to FIGS. 2 and 6A, FIG. 6A is a schematic view of a variation of the first light source 740 in FIG. 2 in the embodiment. The first light source 740 further includes multiple third light emitting units 743 arranged at intervals on the first circuit substrate 741. For example, the third light emitting units 743 and the first light emitting units 742 are configured alternately. The third light emitting units 743 are green light emitting diodes facing the first light-incident surface 732 of the light guide plate 730, so that the third light emitting units 743 of the first light source 740 emit green lights to the first light-incident surface 732 of the light guide plate 730 so as to mix with red lights from the first light emitting units 742.

FIG. 6B is a schematic view of a variation of the second light source 750 in FIG. 2 in the embodiment. Referring to FIGS. 2 and 6B, the second light source 750 further includes multiple fourth light emitting units 753 arranged at intervals on the second circuit substrate 751. For example, the fourth light emitting units 753 and the second light emitting units 752 are configured alternately. The fourth light emitting units 753 are green light emitting diodes facing the second light-incident surface 733 of the light guide plate 730, so that the fourth light emitting units 753 of the second light source 750 emit green lights to the second light-incident surface 733 of the light guide plate 730 so as to mix with blue lights from the second light emitting units 752.

It should be noted that, the green light emitting diodes of the above-mentioned FIGS. 6A and 6B are not limited to whether the single existence or the coexistence.

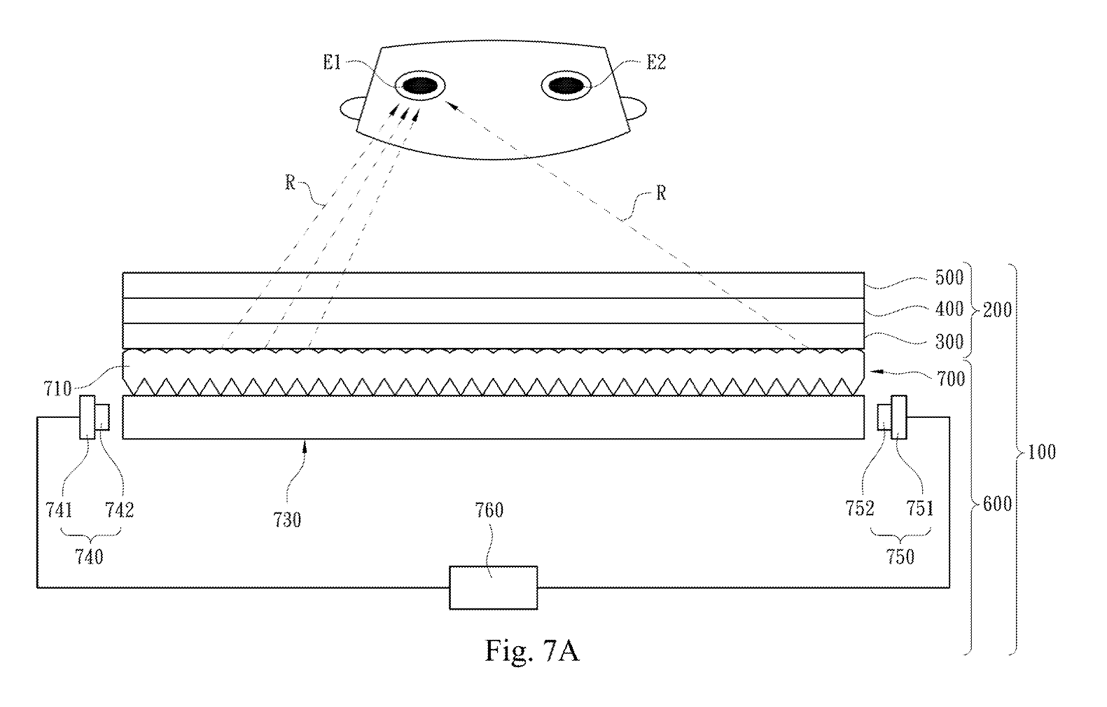

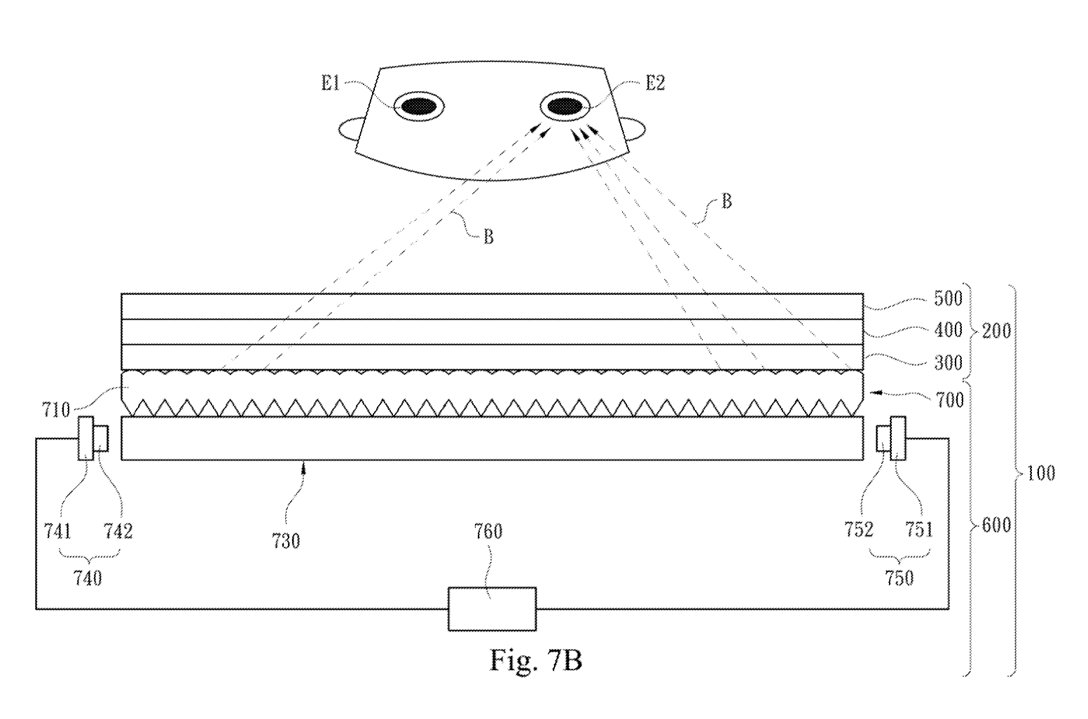

FIGS. 7A and 7B are operational schematic views of the touch naked eyes stereoscopic display 100 of the invention. Referring to FIGS. 7A and 7B, The backlight module 600 further includes a field sequential color (FSC) driving circuit 760 which is electrically connected to the first light source 740 and the second light source 750 and drives the first light source 740 and the second light source 750 in an alternate manner at different time intervals.

In such a way, when the field sequential color (FSC) driving circuit 760 drives the first light source 740 and the second light source 750 in an alternate manner at different time intervals to emit red lights R and blue lights B (FIGS. 7A and 7B), then cooperating with the stereoscopic light split effect of the above-mentioned stereoscopic optical splitting sheet 700, the stereoscopic optical splitting sheet 700 can guide the lights which have been scatted to all directions to one eye E1 or E2 of the viewer, and thus a red picture and a blue picture can be projected to the left eye E1 and the right eye E2 of the viewer respectively in a fast and alternate manner, so as to provide the backlights for the left eye E1 and the right eye E2. Through the principle of the visual duration, a stereoscopic picture with proper colors is formed.

In view of the above, the touch panel of the invention is integrated in the substrate of the touch display module, so that the touch naked eyes stereoscopic display of the invention can be at least simplified only including two sheets of the array substrate and the touch panel (such as a glass sheet). Compared to the prior art, not only the whole thickness and the whole weight can be reduced but also the manufacturing cost can be saved, which can effectively solve the problem that the light weight and thinning of the traditional touch naked eyes stereoscopic display cannot be realized easily, thereby improving the portability space utility rate of electronic products. In addition, through the cooperation between the field sequential color driving circuit and the stereoscopic optical splitting sheet, the touch naked eyes stereoscopic display of the invention does not need color filter so as to improve the light penetration rate, reduce the display power consumption and lower the material cost using colored light filters.

Although the present invention has been described with reference to the preferred embodiments thereof, it is apparent to those skilled in the art that a variety of modifications and changes may be made without departing from the scope of the present invention which is intended to be defined by the appended claims.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A touch naked eyes stereoscopic display, comprising:
a touch display module comprising:
an array substrate;
a touch panel configured on one side of the array substrate; and
a display medium directly configured between the array substrate and the touch panel; and
a backlight module, comprising:
a stereoscopic optical splitting sheet configured on one side of the array substrate being opposite to the touch panel, comprising a first side surface and a second side surface opposite to each other; and
a first light source and a second light source configured on the first side surface and the second side surface of the stereoscopic optical splitting sheet respectively,
wherein, in the first light source and the second light source, only the first light source provides red lights to the stereoscopic optical splitting sheet and only the second light source provides blue lights to the stereoscopic optical splitting sheet.

2. The touch naked eyes stereoscopic display of claim 1, wherein the touch panel comprises:
a substrate; and
a touch sensing electrode pattern formed on an internal side surface of the substrate.

3. The touch naked eyes stereoscopic display of claim 2, wherein the touch sensing electrode pattern comprises:
a plurality of first axial sensing electrodes parallel to each other; and
a plurality of second axial sensing electrodes parallel to each other, wherein the first axial sensing electrodes and the second axial sensing electrodes are configured on the same surface of the substrate.

4. The touch naked eyes stereoscopic display of claim 2, wherein the touch sensing electrode pattern comprises:
a plurality of first axial sensing electrodes parallel to each other; and
a plurality of second axial sensing electrodes parallel to each other, wherein the first axial sensing electrodes and the second axial sensing electrodes are configured on different surfaces of the substrate.

5. The touch naked eyes stereoscopic display of claim 1, wherein the touch panel comprises:
a substrate; and
a touch sensing electrode pattern formed on an external side surface of the substrate.

6. The touch naked eyes stereoscopic display of claim 5, wherein the touch sensing electrode pattern comprises:
a plurality of first axial sensing electrodes parallel to each other; and
a plurality of second axial sensing electrodes parallel to each other, wherein the first axial sensing electrodes and the second axial sensing electrodes are configured on the same surface of the substrate.

7. The touch naked eyes stereoscopic display of claim 5, wherein the touch sensing electrode pattern comprises:
a plurality of first axial sensing electrodes parallel to each other; and
a plurality of second axial sensing electrodes parallel to each other, wherein the first axial sensing electrodes and the second axial sensing electrodes are configured on different surfaces of the substrate.

8. The touch naked eyes stereoscopic display of claim 1, wherein each of the first side surface and the second side surface of the stereoscopic optical splitting sheet is a light-incident surface, the first side surface receives red lights from the first light source and the second side surface receives blue lights from the second light source.

9. The touch naked eyes stereoscopic display of claim 1, wherein the backlight module further comprises:
a light guide plate comprising two light-incident surfaces opposite to each other, and a light outputting surface, wherein the two light-incident surfaces face the first light source and the second light source respectively and the stereoscopic optical splitting sheet is attached on the light outputting surface.

10. The touch naked eyes stereoscopic display of claim 1, wherein the first light source or the second light source further provides green lights.

11. The touch naked eyes stereoscopic display of claim 1, wherein the backlight module further comprises:
a field sequential color driving circuit capable of driving the first light source and the second light source alternately.

12. The touch naked eyes stereoscopic display of claim 1, wherein the stereoscopic optical splitting sheet is directly configured on the side of the array substrate, and comprises a film body and a plurality of optical micro-structures arranged on one surface of the film body facing the array substrate.
